(19) United States
(12) Patent Application Publication
(10) Pub. No.: US 2005/0140913 A1
(43) Pub. Date: Jun. 30, 2005

(54) Flat display device

(76) Inventors: Masahiro Yokota, Minato-ku (JP); Akiyoshi Yamada, Minato-ku (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/054,438

(22) Filed: Feb. 10, 2005

Related U.S. Application Data
(63) Continuation of application No. PCT/JP03/10698, filed on Aug. 25, 2003.

(30) Foreign Application Priority Data
Aug. 29, 2002 (JP) 2002-250279

(51) Int. Cl. G02F 1/1339

(52) U.S. Cl. 349/153

(57) ABSTRACT

A vacuum envelope of a flat display device comprises a rear substrate and a front substrate, located opposite to each other, and a seal portion which seals together respective peripheral edge portions of the front substrate and the rear substrate. A reinforcing portion has a core member harder than the sealing material and is provided outside at least a part of the seal portion. With use of the reinforcing portion, external force that acts on the peripheral edge portions of the substrates can be received by the reinforcing portion, so that external force that acts on the seal portion can be reduced considerably. If any external force is applied, therefore, the seal portion can be prevented from being dislocated or lowered in sealing properties.

### CROSS REFERENCE TO RELATED APPLICATIONS

This is a Continuation Application of PCT Application No. PCT/JP03/10698, filed Aug. 25, 2003, which was published under PCT Article 21(2) in Japanese.

This application is based upon and claims the benefit of priority from prior Japanese Patent Application No. 2002-250279, filed Aug. 29, 2002, the entire contents of which are incorporated herein by reference.

### BACKGROUND OF THE INVENTION

1. Field of the Invention

This invention relates to a flat display device, and more particularly, to a flat display device provided with a front substrate and a rear substrate located opposite to each other and sealed together by a seal portion.

2. Description of the Related Art

In recent years, various flat display devices have been developed as a next generation of lightweight, thin display devices to replace cathode-ray tubes (hereinafter referred to as CRT). These flat display devices include a liquid crystal display (hereinafter referred to as LCD), plasma display panel (hereinafter referred to as PDP), field emission display (hereinafter referred to as FED), surface-conduction electron emission display (hereinafter referred to as SED), etc. In the LCD, the intensity of light is controlled by utilizing the orientation of a liquid crystal. In the PDP, phosphors are caused to glow by ultraviolet rays that are produced by plasma discharge. In the FED, phosphors are caused to glow by electron beams from field-emission electron emitting elements. In the SED, phosphors are caused to glow by electron beams from surface-conduction electron emitting elements.

For example, the FED or SED generally has a front substrate and a rear substrate that are opposed to each other across a predetermined gap. These substrates have their respective peripheral portions joined together by a sidewall in the form of a rectangular frame, thereby constituting a vacuum envelope. A phosphor screen is formed on the inner surface of the front substrate, and a large number of electron emitting elements for use as electron emitting sources that excite the phosphors to luminescence are provided on the inner surface of the rear substrate. A plurality of support members are arranged between the rear substrate and the front substrate in order to support atmospheric load that acts on these substrates. The potential on the rear substrate side is substantially a ground potential, and an anode voltage Va is applied to the phosphor screen. Electron beams emitted from the electron emitting elements are applied to red, green, and blue phosphors that constitute the phosphor screen, whereby the phosphors are caused to glow and display an image.

According to the FED or SED of this type, the thickness of the display device can be reduced to several millimeters or thereabout. When compared with a CRT that is used as a display of an existing TV or computer, therefore, it can be made lighter in weight and thinner.

Display devices of this type are described in, for example, the following documents:

K. Sakai, et al., Euro Display, 18.3L, pp. 569-572, 1996, and

M. Yamaguchi, et al., SID Intl. Symp. Digest Tech. Papers, pp. 52-55, 1997.

In the FED or SED, the inside of the envelope must be kept at high vacuum. Also in the PDP, the envelope must be filled with electric discharge gas after it is internally evacuated once. In the LCD, moreover, the inside of the envelope must be filled with a liquid crystal. Thus, these envelopes are configured so that the respective peripheries of the front substrate and the rear substrate are airtightly sealed together.

On the other hand, various external forces act on an envelope. If a flat display device is transported, overturned, or dropped or if anyone leans against the display device, for example, a torsional or flexural stress is generated in the envelope. Possibly, the envelope may be subjected to deflection caused by heat that is generated when the display device is driven or to a sudden thermal shock caused by heat from a stove or the like. Therefore, the envelope is expected to be resistant enough not to be broken by those external forces.

The resistance of the two substrates that constitute the envelope can be enhanced relatively easily by increasing the thickness of the substrates or adding a reinforcing film or reinforcing frame to the substrates. The resistance of a seal portion can be enhanced by using hard fritted glass or increasing the seal width.

Recently, moreover, a proposal has been made to use an adhesive agent or low-melting metallic material in place of high-melting fritted glass as a sealing material, in order to improve the properties of flat display devices, lower their costs, and delead the devices. In an envelope that uses the sealing material of this type, however, the seal portion is softer than fritted glass and glass substrates. Thus, there is an increasing possibility of the seal portion being dislocated by stress that acts on the envelope or of sealing properties lowering. In a flat display device of which the substrates are thick and tough or a flat display device such as an FED or SED, in which the gap between the two substrates is wide, in particular, stress that acts on the seal portion is increased by deflection of the envelope.

### BRIEF SUMMARY OF THE INVENTION

This invention has been made in consideration of these problems, and its object is to provide a flat display device with improved reliability, in which dislocation of a seal portion and lowering of sealing properties are prevented.

According to an aspect of the invention, there is provided a flat display device comprising: a front substrate and a rear substrate located opposite to each other; a seal portion which is situated between respective peripheral edge portions of the front substrate and the rear substrate and seals together the peripheral edge portions with a sealing material; and a reinforcing portion which is provided outside at least a part of the seal portion and has a core member harder than the sealing material.

According to the flat display device in the aspect of this invention, the reinforcing portion is configured so that the core member is embedded between the front substrate and the rear substrate with an adhesive material or that the core member is fixed to one of the front and rear substrates with the adhesive material and is received by an end face of the other of the front and rear substrates.

According to the flat display device constructed in this manner, the reinforcing portion is provided at the peripheral edge portions of the front substrate and the rear substrate outside the seal portion. Thus, external force that acts on the peripheral edge portions of the substrates can be received by the reinforcing portion, and external force that acts on the seal portion can be reduced considerably. Thus, there may be provided the flat display device with improved reliability and display characteristics, in which dislocation of the seal portion and lowering of sealing properties can be prevented even when external force is applied.

### BRIEF DESCRIPTION OF THE SEVERAL VIEWS OF THE DRAWING

FIG. 1 is a perspective view showing an FED according to a first embodiment of this invention;

FIG. 2 is a sectional view of the FED taken along line II-II of FIG. 1;

FIG. 3 is a plan view of the FED;

FIG. 4 is a plan view typically showing a part of a FED according to a second embodiment of this invention;

FIG. 5 is a plan view typically showing a part of a FED according to a third embodiment of this invention;

FIG. 6 is a sectional view of the FED taken along line VI-VI of FIG. 5;

FIG. 7 is a plan view showing an FED according to a fourth embodiment of this invention;

FIG. 8 is a sectional view taken along line VIII-VIII of FIG. 7; and

FIG. 9 is a sectional view showing an FED according to a further embodiment of this invention.

### DETAILED DESCRIPTION OF THE INVENTION

Embodiments in which this invention is applied to FEDs as flat display devices will now be described in detail with reference to the drawings.

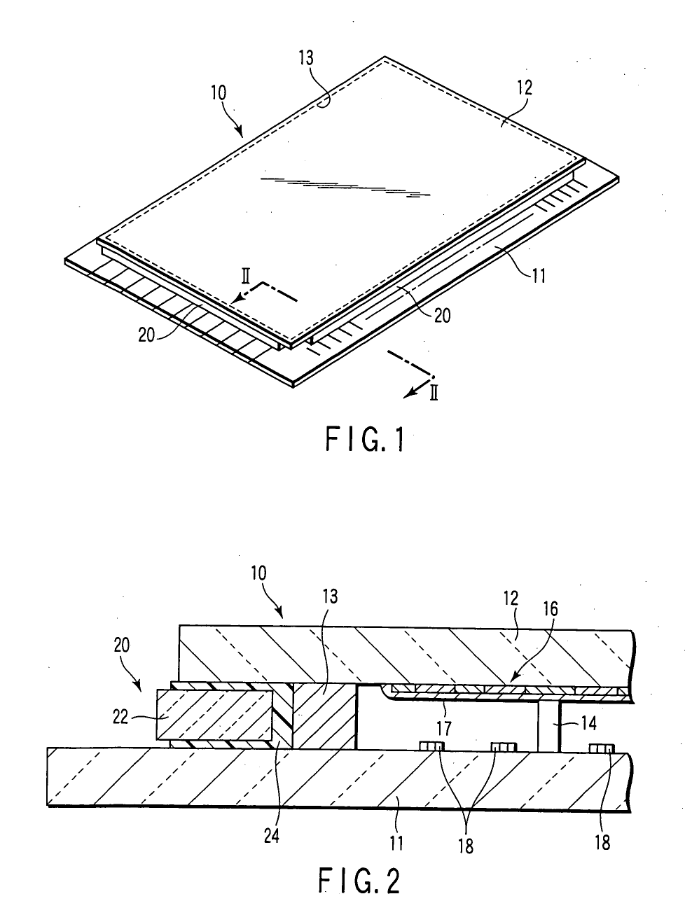

As shown in FIGS. 1 and 2, an FED comprises a rear substrate 11 and a front substrate 12, which are each formed of a transparent rectangular insulating substrate, e.g., a glass plate. These substrates are opposed to each other with a gap between them. The rear substrate 11 and the front substrate 12 have their respective peripheral edge portions sealed together by a seal portion 13, and constitute a flat, rectangular vacuum envelope 10. The seal portion 13, which in the form of a rectangular frame, is situated between the respective peripheral edge portions of the rear substrate 11 and the rear substrate 11 and extend covering the whole peripheries of the substrates.

A phosphor screen 16 is formed on the inner surface of the front substrate 12. The phosphor screen 16 is formed by arranging red, blue, and green phosphor layers and a light shielding layer side by side. These phosphor layers are stripe- or dot-shaped. A metal back 17, which is formed of aluminum or the like and serves as an anode electrode, is formed on the phosphor screen 16. A large number of electron emitting elements 18 are arranged in a matrix on the inner surface of the rear substrate 11 and face the phosphor screen 16.

In order to maintain the gap between the rear substrate 11 and the front substrate 12, a large number of plate-shaped or columnar spacers 14 are located between the substrates. The spacers 14 have their respective opposite ends in engagement with the rear substrate 11 and the front substrate 12, individually, thereby supporting atmospheric pressure load that acts on these substrates and keeping the space between the substrates at a given value.

The rear substrate 11 and the front substrate 12 are each formed of a glass plate of, for example, size 30-50 with a thickness a little less than about 3 mm and are opposed to each other with a gap of about 1 kept by the spacers 14. The seal portion 13 is formed of a low-melting metallic material, e.g., indium, and has a width of about 2 mm.

Outside the seal portion 13, as shown in FIGS. 2 and 3, reinforcing portions 20 for reinforcing the seal portion are provided individually on the respective four sides of the rear substrate 11 and the front substrate 12. Each reinforcing portion 20 has a core member 22 in the form of an elongated plate and adhesive material 24. The core member 22 is fixedly sandwiched between the respective peripheral edge portions of the rear substrate 11 and the front substrate 12 with the adhesive material 24 between them and extends along its corresponding side near the seal portion 13. In this case, each reinforcing portion 20 is located substantially covering the whole length of each side of the substrates except their corner portions.

Each core member 22 is formed of a glass rib having a rectangular cross section about 0.8 mm and 6 mm wide, for example. An inorganic adhesive agent is used as the adhesive material 24, for example. The adhesive material 24 is filled in gaps between the outer surface of the core member 22, rear substrate, front substrate, and seal portion 13, and has a layer thickness of about 0.1 mm.

In the FED constructed in this manner, the electron emitting elements 18 emit electrons toward the phosphor screen 16 when voltage is applied to the electron emitting elements 18 through wires that are formed on the rear substrate 11. Thereupon, the phosphor layers of the phosphor screen 16 are excited to luminescence and display an image.

The following is a description of a manufacturing method for the FED constructed in this manner.

In manufacturing an FED for a 36-inch TV, for example, glass plates with a thickness a little less than 3 mm are prepared for the rear substrate 11 and the front substrate 12, individually. The electron emitting elements 18 and various wires are formed on the rear substrate 11. The spacers 14 are previously fixed on the rear substrate 11 using a low-melting metallic sealing material, such as fritted glass or indium. The phosphor screen 16 and the metal back 17, an aluminum film, are formed on the front substrate 12.

Subsequently, the seal portion 13 is formed by applying indium to a width of 2 mm and a thickness of 1.0 mm along the peripheral edge portion of one substrate, e.g., the rear substrate 11. Indium is an excellent sealing material that has a melting point as low as 156° C., releases an extremely small amount of gas if heated in a vacuum, and degrades the properties of the FED little. An alloy that contains indium or an inorganic or resin-based adhesive agent may be used in place of indium as the sealing material that forms the seal portion 13.

Then, the rear substrate 11 and the rear substrate 11 prepared in the aforesaid manner are sealed together in a vacuum tank to form the vacuum envelope 10. More specifically, the rear substrate 11 and the front substrate 12 are heated to release gas that is adsorbed by the respective surfaces of the individual members, and moreover, these members are cleaned with electron beams. After the rear substrate 11 and the rear substrate 11 are then opposed to each other and located in the vacuum tank, the indium that forms the seal portion 13 is electrically heated to be melted fully. In this state, the rear substrate 11 and the front substrate 12 are pressurized in a direction to approach each other, and the respective peripheral edge portions of the rear substrate 11 and the front substrate 12 are sealed together by the seal portion 13 that is formed of the indium.

Thereafter, the rear substrate 11 and the front substrate 12 are cooled so that the seal portion 13 solidifies, whereupon the vacuum envelope 10 of the FED is formed. Then, on each side of the rear substrate 11 and the front substrate 12, a given amount of the adhesive material 24 is filled between the respective peripheral edge portions of the substrates. Thereafter, the core member 22 is pushed in and sandwiched between the peripheral edge portions of the substrates. In this state, the adhesive material 24 is cured to form the reinforcing portion 20. The FED having the reinforcing portion 20 can be obtained by these processes.

According to the FED constructed in this manner, the reinforcing portions 20 are provided on the peripheral edge portion of the vacuum envelope 10 outside the seal portion 13. Even if any external force acts on the vacuum envelope 10, therefore, the seal portion 13 can be prevented from being dislocated or lowered in sealing properties, so that the reliability can be improved.

More specifically, the inorganic adhesive agent that forms the adhesive material 24 of the reinforcing portions 20 is a relatively hard material among other adhesive agents. However, its hardness against shear force is substantially equal to that of indium, the sealing material, if the seal area is fixed. Therefore, a reinforcing structure without the core member 22 formed of the glass rib that is harder than the sealing material and the adhesive material can produce only a reinforcing effect such that the seal width of the seal portion is increased. Thus, stress that acts on the seal portion 13 of indium cannot be eased in particular.

According to the present embodiment, the hardness of the core member 22 that constitutes the reinforcing portion 20 against shear force is about 2 to 20 times as high as that of the adhesive material 24. The adhesive material 24 has a small enough layer thickness of about 0.1 mm. Therefore, the general hardness of the reinforcing portion 20 is extraordinarily higher than that of the seal portion 13. Accordingly, most of a shear stress that acts on the peripheral edge portions of the rear substrate 11 and the front substrate 12 is concentrated only on the hard reinforcing portion 20. Thus, the shear stress hardly acts on the seal portion 13 of indium that is softer than the reinforcing portion 20.

As described above, most of the stress having so far been acting on the seal portion 13 acts concentratedly on the hard reinforcing portion 20. Preferably, therefore, the reinforcing portion 20 should be formed of a material that never yields and have a certain adhesion area. According to the present embodiment, the reinforcing portion 20 has an adhesion width of about 5 to 6 mm throughout each side of the substrates, so that practically sufficient deflection strength can be obtained.

According to the FED of the present embodiment, as seen from above, the seal portion 13 can be effectively reinforced with use of the simple construction that is provided with the reinforcing portion 20. If any external force acts on the vacuum envelope 10, the seal portion 13 can be prevented from being dislocated or lowered in sealing properties. Thus, there may be obtained the FED with improved reliability and display characteristics, in which the seal portion 13 is highly airtight and the rear substrate 11 and the front substrate 12 can be prevented from being dislocated from each other.

The core member 22 of the reinforcing portion 20 can produce a reinforcing effect only if it is formed of a material that is harder than at least the seal portion 13 and the adhesive material 24. It can enjoy a desired hardness if it is formed of metal or ceramics in place of the aforesaid glass.

The adhesive material 24 of the reinforcing portion 20 is not limited to the aforementioned inorganic adhesive agent, and can enjoy nearly desired hardness and reinforcing effect if it is formed of a resin material, such as an epoxy resin, or material prepared by adding a filler of silica or alumina to the resin material.

The formation area for the reinforcing portion 20 is not limited to the case of the foregoing embodiment, and may alternatively be provided covering the whole peripheries of the substrates outside the seal portion 13. The reinforcing portion 20 can enjoy a reinforcing effect only if it is provided along at least one side of each of the rear and front substrates in place of the four sides.

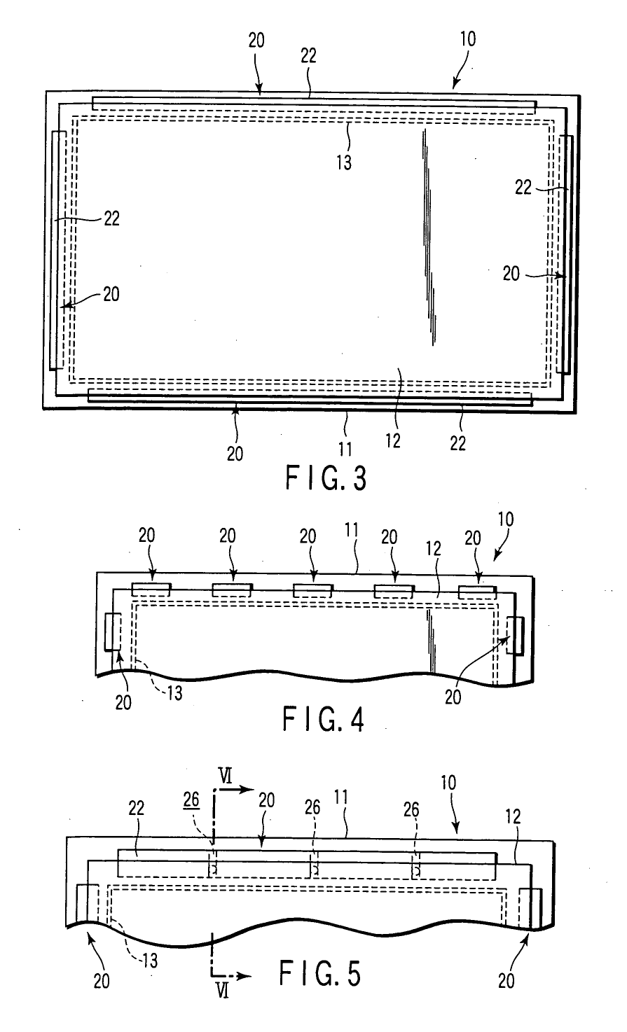

As in a second embodiment shown in FIG. 4, a plurality of reinforcing portions 20 may be provided intermittently on each side of a rear substrate 11 and a front substrate 12. Functions and effects similar to those of the foregoing first embodiment can be also obtained in this case.

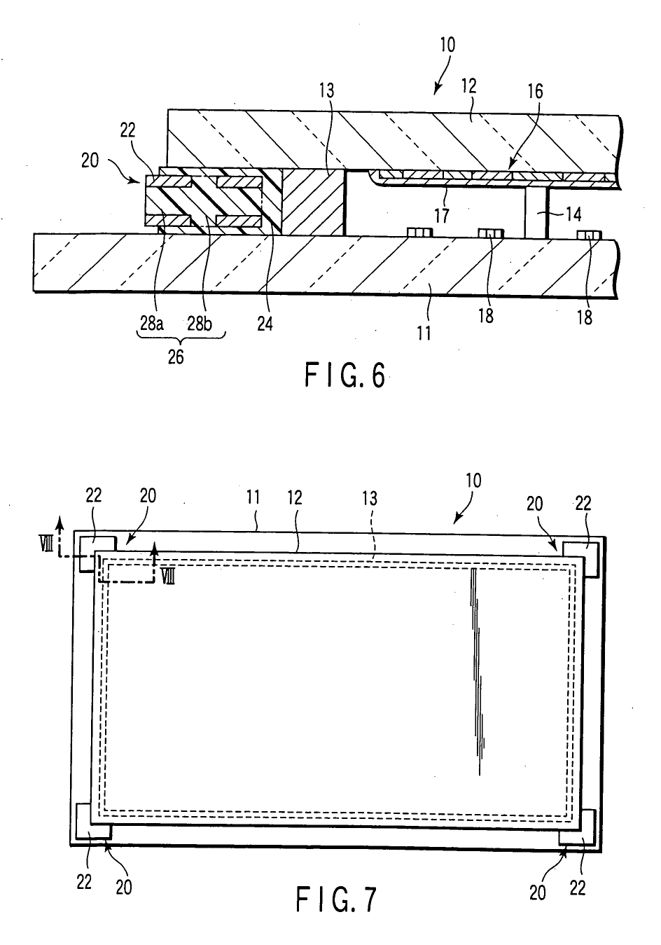

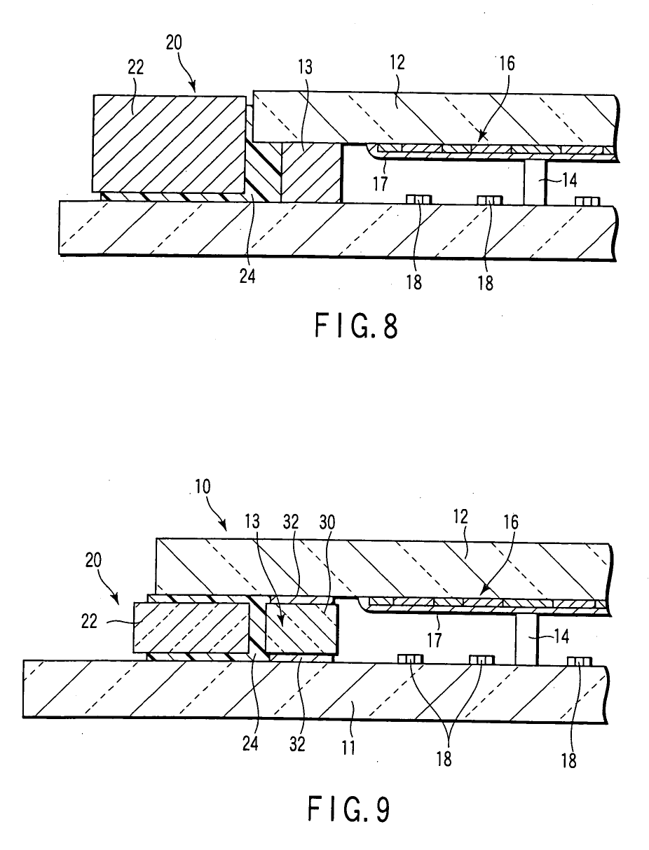

According to a third embodiment shown in FIGS. 5 and 6, a core member 22 that constitutes each reinforcing portion 20 is provided with a filling portion 26 through which an adhesive material 24 is loaded onto an adhesive surface. A plurality of filling portions 26 are provided individually for the core members 22 and arranged at spaces in the longitudinal direction of the core members 22. Each filling portion 26 has a pair of through holes 28a and 28b that individually extend at right angles to the longitudinal direction of the core member 22 and at right angles to each other. The core member 22 is fixedly sandwiched between the respective peripheral edge portions of the rear substrate 11 and the front substrate 12 with the adhesive material 24 between them and extends along a side of each substrate near a seal portion 13.

In forming the reinforcing portion 20 with the aforesaid configuration, the core member 22 is set between the respective peripheral edge portions of the rear substrate 11 and the front substrate 12 at each side of the substrates. Thereafter, the adhesive material 24 is injected through the through holes 28a and 28b of each filling portion 26 and guided onto the adhesive surface. More specifically, the adhesive material 24 is filled through the filling portion 26 into gaps between the outer surface of the core member 22, rear substrate, front substrate, and seal portion 13. The reinforcing portion 20 is formed by curing the adhesive material 24 thereafter.

According to the FED constructed in this manner, the core member 22 of the reinforcing portion 20 is provided with the filling portion 26. Therefore, the adhesive material 24 can be loaded onto the adhesive surface through the filling portion after the core member is set between the respective peripheral edge portions of the rear substrate 11 and the front substrate 12. In this case, the layer thickness of the adhesive material 24 that is situated in the gaps between the outer surface of the core member 22, rear substrate, front substrate, and seal portion 13 can be formed thinner than in the foregoing case of the first embodiment. Since the adhesive material layer can be thinned, the size of the core member 22 can be increased correspondingly. Thus, the reinforcing effect of the reinforcing portion 20 can be improved further.

Other configurations of the third embodiment are the same as those of the first embodiment, so that like reference numerals are used to designate like portions, and a detailed description of those portions is omitted. Functions and effects similar to those of the first embodiment can be also obtained with the third embodiment.

If the length of the reinforcing portion 20 is short, at least one filling portion 26 should only be provided in each reinforcing portion. Each filling portion 26 is expected only to have at least one outlet, which opens in the gaps between the outer surface of the core member 22, rear substrate, front substrate, and seal portion 13, and at least one injection port that opens outward from a vacuum envelope 10. The filling portion 26 is not limited to the aforesaid through holes and may be formed of a groove that is formed on the surface of the core member 22.

The following is a description of an FED according to a fourth embodiment of this invention. In the foregoing embodiment, the core member of each reinforcing portion is fixedly sandwiched between the respective peripheral edge portions of the rear substrate 11 and the front substrate 12 with the adhesive material 24 between them and extends along a side of each substrate near the seal portion 13. According to the fourth embodiment, on the other hand, reinforcing portions 20 are provided individually on the corner portions of a vacuum envelope 10. Each reinforcing portion 20 has a substantially L-shaped bent core member 22. The core members 22 are located opposite to a surface of a rear substrate 11 and side edges of the corner portions of a front substrate 12 outside a seal portion 13, and are fixed by an adhesive material 24 that is situated in gaps between these substrates, seal portion, and core members. Other configurations are the same as those of the foregoing first embodiment, so that like reference numerals are used to designate like portions, and a detailed description of those portions is omitted.

According to the fourth embodiment, the front substrate 12 and the reinforcing portions 20 are in compressive (or tensile) relation to each other, not in shearing relation. Therefore, the core members 22 can secure satisfactory yield strength although the area of adhesion to the front substrate is substantially equal to the thickness of the substrate. For the shear strength between the rear substrate 11 and the reinforcing portions 20, reinforcing only the corner portions of the substrate by the reinforcing portions 20 can produce a satisfactory reinforcing effect, taking advantage of the wide areas of the corner portions of the upper surface of the rear substrate 11 where none of drive wires and the like exist. Thus, substantially the same functions and effects as those of the first embodiment can be also obtained with the fourth embodiment.

At least two reinforcing portions 20 should only be provided opposite to each other with one of the substrates between them. Further, the reinforcing portions can fulfill their reinforcing effect if they are located adjacent to sides of the substrates instead of being provided on the corner portions. Also in the fourth embodiment, each core member 22 may be provided with the aforesaid filling portion for loading the adhesive material onto the adhesive surface, whereby the adhesive material can be filled after the core members are located in given positions relative to the substrate.

In the first to fourth embodiments described above, the seal portion 13 that seals together the respective peripheral edge portions of the rear substrate 11 and the front substrate 12 is formed of the sealing material only. Alternatively, however, a seal portion 13 may be formed by combining a frame-shaped sidewall 30 of, e.g., glass and a sealing material 32 that is located between the sidewall and a rear substrate 11 and between the sidewall and a front substrate 12, as shown in FIG. 9.

Further, this invention is not limited to the embodiments described above, and various modifications may be effected therein without departing from the scope of the invention. For example, this invention is not limited to FEDs and may be also applied to any other flat image display devices, such as SEDs, PDPs, etc. The dimensions, shapes, etc. of the individual component members can be variously changed as required. The core member that constitutes the reinforcing portion, in particular, is not limited to the shape of a plate that has a rectangular cross section, and may be shaped optionally.

1. A flat display device comprising:
a front substrate and a rear substrate located opposite to each other;
a seal portion which is situated between respective peripheral edge portions of the front substrate and the rear substrate and seals together the peripheral edge portions with a sealing material; and
a reinforcing portion which is provided outside at least a part of the seal portion and has a core member harder than the sealing material.

2. The flat display device according to claim 1, wherein the core member of the reinforcing portion is fixed between the respective peripheral edge portions of the front substrate and the rear substrate with an adhesive material therebetween.

3. The flat display device according to claim 2, wherein the reinforcing portion is provided substantially covering the overall length of at least one side of each of the front and rear substrates.

4. The flat display device according to claim 2, wherein a plurality of reinforcing portions are provided intermittently along at least one side of each of the front and rear substrates.

5. The flat display device according to claim 1, wherein the core member of the reinforcing portion faces a surface of one of the front and rear substrates and a side edge of the other substrate and is fixed to the surface and the side edge with the adhesive material.

6. The flat display device according to claim 5, wherein a plurality of said core members of the reinforcing portions are provided individually opposite to a plurality of positions on the side edge of the other substrate.

7. The flat display device according to claim 2, wherein the core member has a filling portion which guides the sealing material supplied from outside the front substrate and the rear substrate to adhesive surfaces between the core member and the front and rear substrates.

8. The flat display device according to claim 1, wherein the core member is formed of glass, ceramics, or metal.

9. The flat display device according to claim 1, wherein the adhesive material is an organic adhesive material or a resin-based adhesive material.

10. The flat display device according to claim 1, wherein the sealing material is an adhesive material or low-melting metal.

11. The flat display device according to claim 1, wherein the sealing material is a low-melting metallic material which contains indium or an indium alloy.

12. The flat display device according to claim 1, wherein a gap between the front substrate and the rear substrate is 1 mm or more.

13. The flat display device according to claim 1, which comprises a phosphor screen formed on an inner surface of the front substrate, a plurality of electron emission sources which are provided on the rear substrate and excite the phosphor screen, and a plurality of spacers provided between the front substrate and the rear substrate.
